(19) United States
(12) Patent Application Publication
(10) Pub. No.: US 2011/0050993 A1
(43) Pub. Date: Mar. 3, 2011

(54) MOTION ESTIMATING METHOD AND IMAGE PROCESSING APPARATUS

(75) Inventors: Yonggang WANG, Beijing (CN); Seung-hoon HAN, Seoul (KR)

(73) Assignee: SAMSUNG ELECTRONICS CO., LTD., Suwon-si (KR)

(21) Appl. No.: 12/778,709

(22) Filed: May 12, 2010

(30) Foreign Application Priority Data
Aug. 27, 2009 (KR) 10-2009-0079551

(51) Int. Cl. H04N 7/01

(52) U.S. Cl. 348/452; 348/E07.003

(57) ABSTRACT

Disclosed are a motion estimating method for an image and an image processing apparatus. A motion estimating method of an image, the method including: calculating a candidate motion vector by using one of a forward motion estimation and a backward motion estimation from a reference block extracted from one of first and second images that are input consecutively, and a search area extracted from the other one of the first and second images; calculating a pseudo motion vector corresponding to the other one of the forward motion estimation and the backward motion estimation by using the candidate motion vector; and interpolating the first and second images by using at least one of the candidate motion vector and the pseudo motion vector.

### CROSS-REFERENCE TO RELATED APPLICATION

This application claims priority from Korean Patent Application No. 10-2009-0079551, filed on Aug. 27, 2009, in the Korean Intellectual Property Office, the disclosure of which is incorporated herein by reference.

### BACKGROUND

1. Field

Apparatuses and methods consistent with the exemplary embodiments relate to a motion estimating method for an image and an image processing apparatus, and more particularly, to a motion estimating method for an image and an image processing apparatus which performs a single-ward motion estimation.

2. Description of the Related Art

An image processing operation which converts a frame rate or converts an interlaced image into a progressive image is accompanied by a motion estimation operation between image frames.

The image estimation technique which estimates a motion vector for image compensation is a core technique to improve a picture quality of various video processing systems. Generally, the motion estimation operation is performed by using a block matching algorithm.

The block matching algorithm estimates a single motion vector per block by comparing two frames and field images that are input consecutively, by block. The motion vector is estimated by using a motion estimation error, e.g., a sum of absolute difference (SAD), and the estimated motion vector is used to compensate a motion.

The motion estimation is classified into a forward motion estimation which estimates a motion of a current frame based on a previous frame, a backward motion estimation which estimates a motion of a previous frame based on a current frame, and a bi-ward motion estimation which performs both the forward motion estimation and the backward motion estimation. If a motion is compensated by performing a single-ward motion estimation operation such as the forward motion estimation or the backward motion estimation, halo may arise from an occlusion area like a boundary of an object or errors may occur. Meanwhile, the bi-ward motion estimation operation provides more accurate motion estimation, but adds load to hardware and consumes more memory to calculate data.

### SUMMARY

Accordingly, it is an aspect of the exemplary embodiments to provide a motion estimation method of an image and an image processing apparatus which reduces costs and load to hardware.

Also, it is another aspect of the exemplary embodiments to provide a motion estimation method for an image and an image processing apparatus which acquires an effect of a bi-ward motion estimation operation by using a pseudo motion vector.

Additional aspects and/or advantages of the exemplary embodiments will be set forth in part in the description which follows and, in part, will be obvious from the description, or may be learned by practice of the exemplary embodiments.

The foregoing and/or other aspects are also achieved by providing a motion estimating method of an image, the method including: calculating a candidate motion vector by using one of a forward motion estimation and a backward motion estimation from a reference block extracted from one of first and second images that are input consecutively, and a search area extracted from the other one of the first and second images; calculating a pseudo motion vector corresponding to the other one of the forward motion estimation and the backward motion estimation by using the candidate motion vector; and interpolating the first and second images by using at least one of the candidate motion vector and the pseudo motion vector.

The calculating the pseudo motion vector may include classifying the candidate motion vectors into predetermined groups corresponding to peripheral blocks of the candidate motion vector; and selecting one of center vectors from the groups, as the pseudo motion vector.

The selecting the pseudo motion vector may include selecting a vector whose value V in a following formula is the largest among the center vectors, as the pseudo motion vector, in which

Vj=(Pj)wp*(Dj)wd [Formula 1]

1≦j≦k, k is the number of the groups;

Dj is a distance between the candidate motion vector and the center vector;

Pj is the number of the candidate motion vectors included in the groups with respect to the number of candidate motion vectors corresponding to the peripheral blocks; and wp and wd are a weight value and a constant.

The interpolating the first image and the second image may include setting a vector having a smaller sum of absolute difference (SAD) between a SAD corresponding to the candidate motion vector and a SAD corresponding to the pseudo motion vector, as a final motion vector; and generating an interpolated image between the first image and the second image by using the final motion vector.

The interpolating the first image and the second image may include determining a covering area or an uncovering area if a difference between the SAD corresponding to the candidate motion vector and the SAD corresponding to the pseudo motion vector exceeds a predetermined value.

Another aspect is to provide an image processing apparatus including: a candidate motion vector calculator which may calculate a candidate motion vector by using one of a forward motion estimation and a backward motion estimation from a reference block extracted from one of a first image and a second image that are input consecutively, and a search area extracted from the other one of the first image and the second image; a pseudo motion vector calculator which may calculate a pseudo motion vector corresponding to the other one of the forward motion estimation and the backward motion estimation by using the candidate motion vector; and a motion compensator which may interpolate between the first image and the second image by using at least one of the candidate motion vector and the pseudo motion vector.

### BRIEF DESCRIPTION OF THE DRAWINGS

The above and/or other aspects will become apparent and more readily appreciated from the following description of the embodiments, taken in conjunction with the accompanying drawings of which:

FIG. 1 is a control block diagram of an image processing apparatus according to an exemplary embodiment;

FIG. 2 is a control flowchart which illustrates a motion estimating method of the image processing apparatus in FIG. 1;

FIG. 3 illustrates a motion estimation operation with respect to a direction if an object moves;

FIG. 4 is a control flowchart which illustrates a method of calculating a pseudo motion vector by the image processing apparatus in FIG. 1;

FIG. 5 illustrates peripheral blocks to calculate a pseudo motion vector in the image processing apparatus in FIG. 1; and

FIG. 6 illustrates frame images to describe a motion interpolation operation of the image processing apparatus in FIG. 1.

### DETAILED DESCRIPTION OF EXEMPLARY EMBODIMENT

Hereinafter, exemplary embodiments will be described with reference to accompanying drawings, wherein like numerals refer to like elements and repetitive descriptions will be avoided as necessary. Expression such as “at least one of,” when preceding a list of elements, modifies the entire list of elements and does not modify the individual elements of the list.

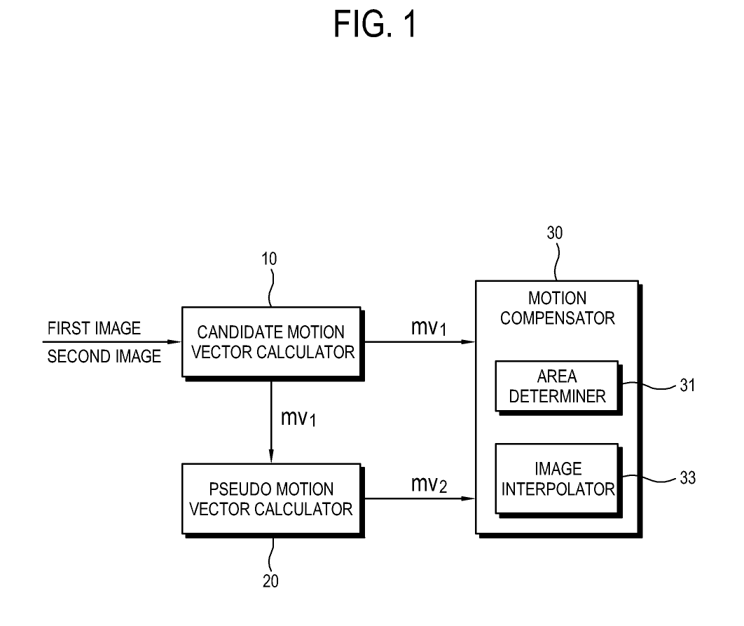

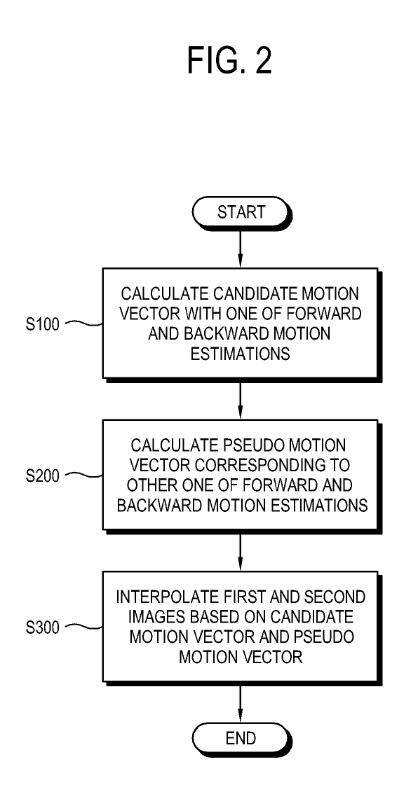

FIG. 1 is a control block diagram of an image processing apparatus according to an exemplary embodiment FIG. 2 is a control flowchart of a motion estimating method of the image processing apparatus in FIG. 1. As shown therein, the image processing apparatus includes a candidate motion vector calculator 10, a pseudo motion vector calculator 20 and a motion compensator 30. The image processing apparatus estimates a motion with a block matching algorithm, and converts a frame rate or interpolates an image by using the motion estimation operation. The block matching algorithm estimates a single motion vector per block by comparing two consecutive input frames or field images by block.

The candidate motion vector calculator 10 calculates a candidate motion vector by using a reference block extracted from one of first and second consecutive images and a search area extracted from the other one of the first and second consecutive images according to one of a forward motion estimation and a backward motion estimation (S100). The first image and the second image may include field images including even line images or odd line images only, and frame images including both even line images and odd line images. The first image and the second image are input consecutively. Assuming that the first image is input prior to the second image, a forward motion estimation is defined as an estimation of a motion of a reference block by searching a search area of the second image with the reference block of the first image. Meanwhile, a backward motion estimation is defined as an estimation of a motion of a reference block by searching a search area of the second image with the reference block of the second image. The search direction is only a relative notion. The candidate motion vector may be estimated by using a motion estimation error, e.g., a sum of absolute difference (SAD). A block which has a smallest SAD in the block within the search area becomes a matching block of the reference block while a vector between the reference block and the matching block is set as the candidate motion vector. The candidate motion vector according to the present exemplary embodiment is named as mv1 to be distinguished from a pseudo motion vector which will be described later.

The pseudo motion vector calculator 20 calculates a pseudo motion vector corresponding to the other one of the forward motion estimation and the backward motion estimation by using the pseudo motion vector mv1 (S200). Hereinafter, the pseudo motion vector will be referred to as mv2.

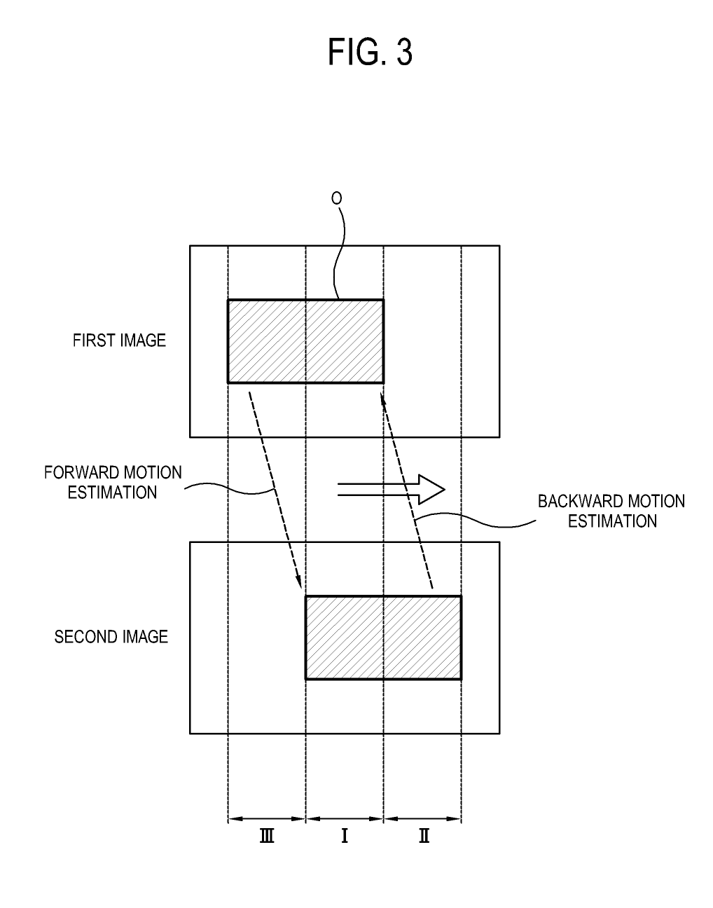

FIG. 3 illustrates a motion estimation operation with respect to a direction when an object moves. As shown therein, if an object O moves through the first and second images, there occur three areas: a first area I where the object O overlaps in the first and second images, a second area II where the object O exists only in the second image which is input following the first image, and a third area III where the object O exists only in the first image input prior to the second image. The first area I enables both the forward motion estimation and the backward motion estimation. The first area I is also referred to as a normal area. The second area II where an existing image (first image) is covered by an object O of a new image (second image) is referred to as a covering area. To that end, the third area III where the existing image (first image) is exposed by a movement of the object O of the new image (second image) is also referred to as an uncovering area. In the covering area II, the backward motion estimation which estimates a motion by searching the first image based on the second image is available, and the forward motion estimation which searches the second image based on the first image is not available. This is because the image corresponding to the covering area II of the first image does not exist in the second image. Conversely, in the uncovering area III, the forward motion estimation which searches the second image based on the first image is available, but the backward motion estimation is not available since the image corresponding to the uncovering area III of the second image does not exist in the first image. Therefore, it is preferable that both the forward and backward motion estimations are available for an accurate estimation, and the image interpolation is performed by using the motion vector based on the bi-ward motion estimation. The bi-ward motion estimation requires twice logic of a single-ward motion estimation. Accordingly, load to hardware and a consumption of a memory capacity increase. That is, a larger search area causes more calculation volume, memory bandwidth and internal memory consumption, thereby adding load to hardware.

According to the present exemplary embodiment, a motion estimation operation is performed by using a motion estimation logic with respect to a single particular direction, and a pseudo motion vector mv2 which estimates a motion in an opposite direction is calculated by the pseudo motion vector calculator 20. That is, only a part of hardware logic which is necessary for the bi-ward motion estimation is used to estimate a motion, and a motion vector with respect to the remaining direction is generated by a predetermined calculation to thereby reduce the foregoing issues. For example, if the candidate motion vector calculator 10 calculates the candidate motion vector mv1 through the backward motion estimation, the pseudo motion vector mv2 which is calculated by the pseudo motion vector calculator 20 corresponds to a motion vector which may be obtained from the forward motion vector. In this case, a motion in the uncovering area III where the motion is not estimated by the backward motion estimation may be estimated through the pseudo motion vector mv2.

The motion compensator 30 interpolates between the first image and the second image by using at least one of the candidate motion vector mv1 and the pseudo motion vector mv2 (S300). The motion compensator 30 includes an area determiner 31 which determines the foregoing first to third areas I to III through the received candidate motion vector mv1 and the pseudo motion vector mv2, and an image interpolator 33 which interpolates an image by using the determination result of the area determiner 31, and the candidate motion vector mv1 and the pseudo motion vector mv2. The interpolation of an image may be performed by using either the candidate motion vector mv1 or the pseudo motion vector mv2 or both of them. The method of interpolating the image by using a plurality of vectors or bi-ward motion vectors may include various known methods, without limitation to a particular method.

According to another exemplary embodiment, the motion compensator 30 may additionally receive information on the area instead of determining the covering area and the uncovering area of the image based on the motion vectors mv1 and mv2.

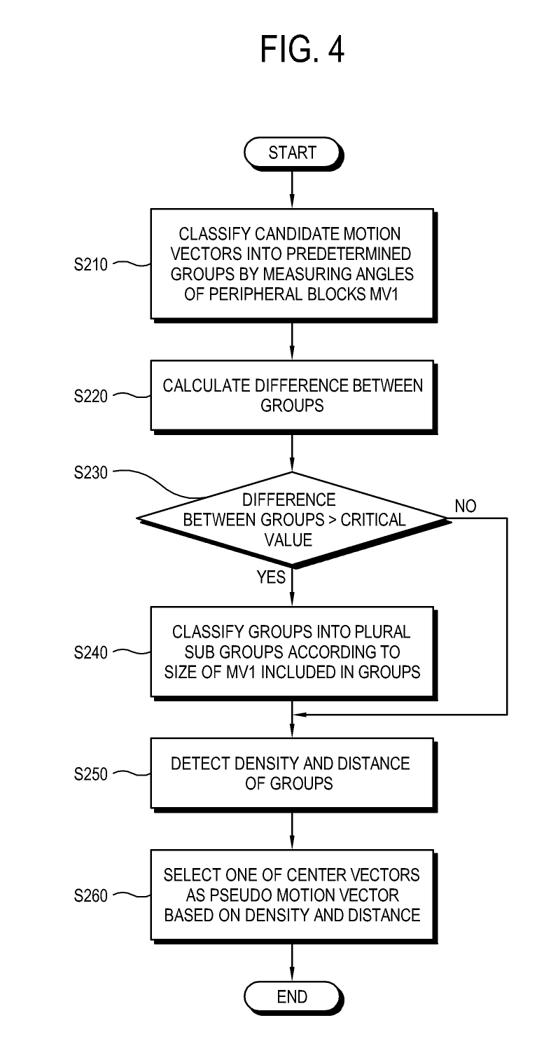

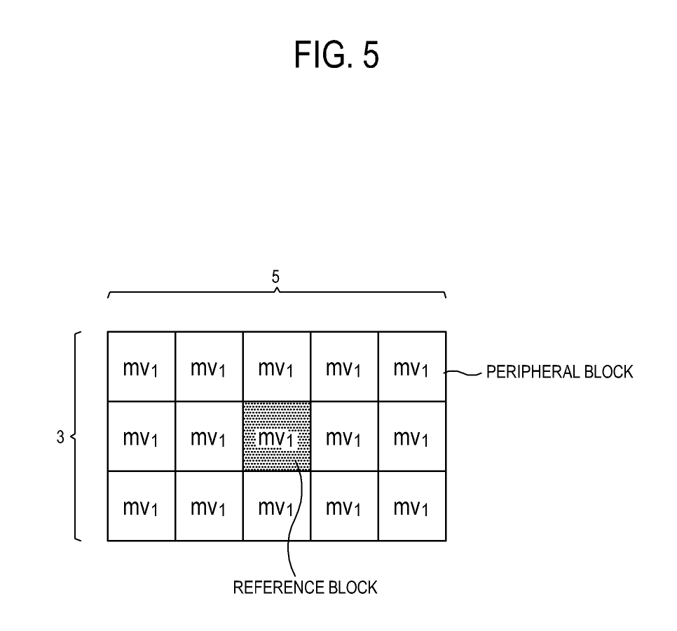

FIG. 4 is a control flowchart which illustrates a method of calculating the pseudo motion vector mv2. FIG. 5 illustrates peripheral blocks to calculate the pseudo motion vector mv2. The calculation of the pseudo motion vector mv2 according to the exemplary embodiment will be described with reference to FIGS. 4 and 5. The pseudo motion vector calculator 20 according to the present exemplary embodiment calculates the pseudo motion vector mv2 by applying clustering techniques using peripheral blocks of a particular reference block.

The pseudo motion vector calculator 20 first measures angles of candidate motion vectors mv1 for the peripheral blocks of a particular reference block, and classifies the candidate motion vectors mv1 into predetermined groups (S210). As shown in FIG. 5, a plurality of blocks which is adjacent to the reference block is set as peripheral blocks. The peripheral blocks according to the present exemplary embodiment are set as 15 blocks including the reference block in a 5×3 basis. The candidate motion vectors mv1 which are estimated from the peripheral blocks are classified into predetermined groups according to angles. The predetermined groups may be classified into four groups based on a quadrant (0 to 90 degrees, 90 to 180 degrees, 180 to 270 degrees and 270 to 360 degrees) by angle or classified into groups whose angles are in a cluster. The number of groups may vary.

The pseudo motion vector calculator 20 calculates a difference between the groups and determines whether the difference exceeds a predetermined critical value (S220 and S230). This operation is performed to determine whether to additionally classify the predetermined groups to classify candidate vectors for calculating the pseudo motion vector mv2 in detail. The critical value may vary depending on the extent of the classification, and is not limited to a particular value.

If the difference between the predetermined groups exceeds the critical value, the predetermined groups are further classified into a plurality of sub groups according to the size of the candidate motion vectors mv1 included in the groups (S240). The predetermined groups may be classified into two or three or more sub groups according to the size of the candidate motion vectors mv1.

If the classification of the groups is finalized, a density and a distance of the groups are detected (S250). The density Pi of the groups means the number of the candidate motion vectors mv1 included in the groups with respect to the number of the candidate motion vectors mv1 corresponding to the peripheral blocks. The distance Di of the groups means a distance between the candidate motion vector mv1 and center vectors of the groups. For example, if a first group includes three candidate motion vectors, the density of the first groups is 3/15.

The pseudo motion vector calculator 20 selects one of the center vectors of the groups, as the pseudo motion vector mv2, based on the detected density Pi and the distance Di (S260). According to the present exemplary embodiment, a vector whose value V in a following Equation 1 is the largest, is selected as the pseudo motion vector mv2.

Vj=(Pj)wp*(Dj)wd [EQN. 1]

in which,

1≦j≦k, k is the number of the groups,

Dj is a distance between the candidate motion vector mv1 of a particular reference block and the center vector,

Pj is the number of the candidate motion vectors mv1 included in the groups with respect to the number of candidate motion vectors mv1 corresponding to the peripheral blocks, and wp and wd are a weight value and a constant.

The pseudo motion vector calculator 20 may use another formula or other variables than the density and the distance to find the pseudo motion vector mv2 having a direction opposite to the candidate motion vector mv1. That is, as long as the relation or correlation between the candidate motion vector mv1 and the pseudo motion vector mv2 is shown, any known algorithm or formula may be used.

The motion compensator 30 interpolates between the first image and the second image based on two vectors input from the pseudo motion vector calculator 20 and the candidate motion vector calculator 10. During the foregoing process, the motion compensator 30 sets a vector having a smaller sum of absolute difference (SAD) between the SAD corresponding to the candidate motion vector mv1 and the SAD corresponding to the pseudo motion vector mv2, as a final motion vector, through which an interpolated image is generated.

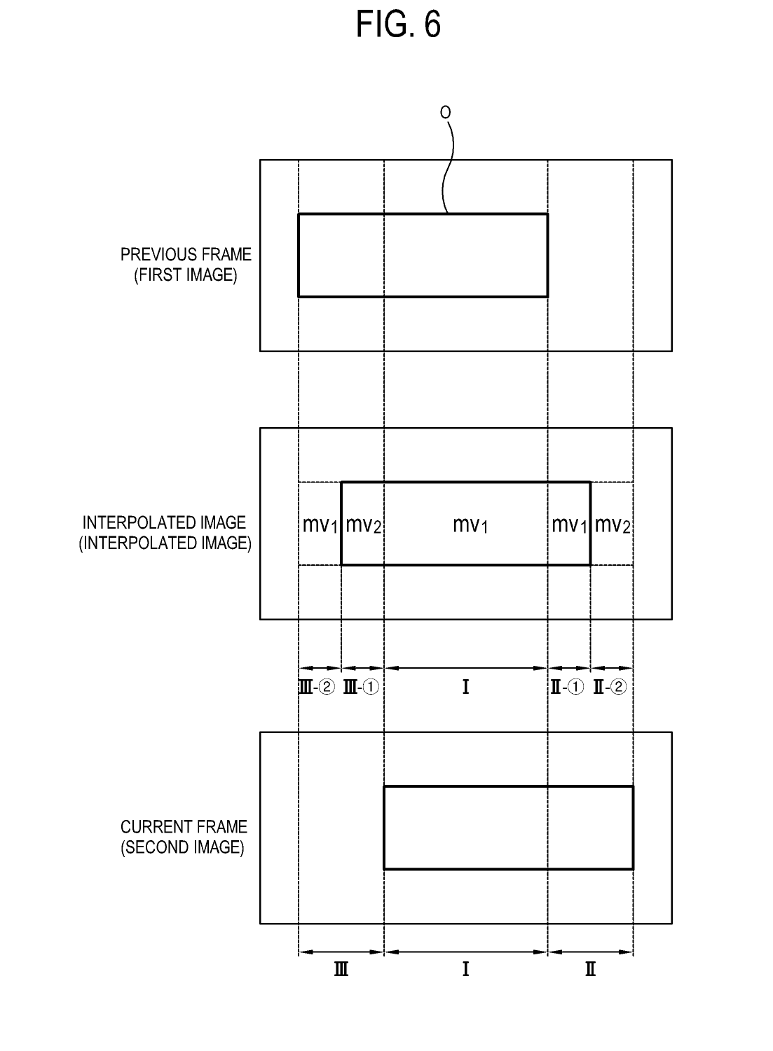

FIG. 6 illustrates frame images to describe an image interpolation of the motion compensator 30. As shown therein, an object O of a previous frame corresponding the first image moves to the right from the current frame corresponding to the second image. If an interpolated frame as an interpolated image is generated on the basis of the bi-ward motion estimation vectors, the motion compensator 30 may interpolate the image by using one of a motion vector of a previous frame and a motion vector of a current frame corresponding to an area to be interpolated. According to the present exemplary embodiment, a vector corresponding to a motion vector of the current frame is a candidate motion vector mv1, for which the backward motion estimation is performed. And a vector corresponding to a motion vector of the previous frame is a pseudo motion vector mv2, for which the forward motion estimation is performed. The bi-ward motion estimation may be performed in the first area I, and the difference of the SAD between the candidate motion vector mv1 and the pseudo motion vector mv2 is not great. Accordingly, the image in the first area I is interpolated on the basis of the candidate motion vector mv1.

As for an interpolation in the covering area II, in a first sub covering area II-\textcircled{1}, where image information on the object O is found from the previous frame, a SAD corresponding to the candidate motion vector mv1 resulting from the backward motion estimation may be smaller than a SAD corresponding to the pseudo motion vector mv2. Accordingly, in the first sub covering area II-\textcircled{1}, the image is interpolated on the basis of the candidate motion vector mv1. Conversely, in a second sub covering area II-\textcircled{2} where image information on the object O is not found from the previous frame, a SAD corresponding to the pseudo motion vector mv2 resulting from the forward motion estimation may be smaller than a SAD corresponding to the candidate motion vector mv1. That is, in the second sub covering area II-\textcircled{2}, the image is interpolated on the basis of the pseudo motion vector mv2.

As for an interpolation in the uncovering area III, in a first sub uncovering area III-\textcircled{1} where image information on a background is not found from the previous frame, a SAD corresponding to the pseudo motion vector mv2 is smaller than a SAD corresponding to the candidate motion vector mv1. Meanwhile, in a second sub uncovering area III-\textcircled{2} where image information on the background is found from the previous frame, the image may be interpolated by using the candidate motion vector mv1.

In sum, the motion compensator 30 may compare the SAD of two vectors to determine which area is the normal area I, the covering area II or the uncovering area III. If the SAD of each vector exceeds a predetermined value, i.e., if it is determined that the difference of SAD between the two vectors is larger than a particular standard, the area is determined to be the covering area II or the uncovering area III. The image in the area which is determined to be the covering area II or the uncovering area III may be interpolated by the motion vector having a smaller SAD. The interpolation of the image by the motion compensator 30 using the forward motion vector mv1 and the backward motion vector mv2 is known in the art, and any method can be applied in the exemplary embodiment.

As described above, the exemplary embodiments interpolate an image by using the bi-ward motion estimation, and performs one of the forward motion estimation and the backward motion estimation and then calculates the motion vector with respect to the other one of the forward motion estimation and the backward motion estimation. This reduces load to hardware while ensuring as accurate motion estimation as that with the bi-ward motion estimation.

As described above, a motion estimating method of an image and an image processing apparatus according to the exemplary embodiments reduce costs and load to hardware.

Further, the motion estimating method of an image and the image processing apparatus according to the exemplary embodiments acquire an effect of a bi-ward motion estimation through a pseudo motion vector.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A motion estimating method of an image, the method comprising:
calculating a candidate motion vector by using one of a forward motion estimation and a backward motion estimation from a reference block extracted from one of a first image and a second image that are input consecutively, and a search area extracted from another of the first and the second images;
calculating a pseudo motion vector corresponding to the other of the forward motion estimation and the backward motion estimation by using the candidate motion vector; and
interpolating between the first and the second images by using at least one of the candidate motion vector and the pseudo motion vector.

2. The method according to claim 1, wherein the calculating the pseudo motion vector comprises:
classifying the candidate motion vector into one of predetermined groups corresponding to peripheral blocks of the candidate motion vector; and
selecting one of center vectors from the predetermined groups, as the pseudo motion vector.

3. The method according to claim 2, wherein the selecting the one of center vectors from the predetermined groups, as the pseudo motion vector comprises selecting a vector whose value V in a following formula is a largest among the center vectors, as the pseudo motion vector, in which
Vj=(Pj)wp*(Dj)wd
1≦j≦k, k is a number of the predetermined groups;
Dj is a distance between the candidate motion vector and the center vector;
Pj is a number of the candidate motion vectors included in the predetermined groups with respect to the number of candidate motion vectors corresponding to the peripheral blocks; and
wp and wd are a weight value and a constant, respectively.

4. The method according to claim 1, wherein the interpolating between the first image and the second image comprises setting a vector having a smaller sum of absolute difference (SAD) between a SAD corresponding to the candidate motion vector and a SAD corresponding to the pseudo motion vector, as a final motion vector; and
generating an interpolated image between the first image and the second image by using the final motion vector.

5. The method according to claim 1, wherein the interpolating between the first image and the second image comprises determining a covering area or an uncovering area if a difference between the SAD corresponding to the candidate motion vector and the SAD corresponding to the pseudo motion vector exceeds a predetermined value.

6. An image processing apparatus comprising:
a candidate motion vector calculator which calculates a candidate motion vector by using one of a forward motion estimation and a backward motion estimation from a reference block extracted from one of a first image and a second image that are input consecutively, and a search area extracted from another of the first image and the second image;
a pseudo motion vector calculator which calculates a pseudo motion vector corresponding to the other of the forward motion estimation and the backward motion estimation by using the candidate motion vector; and
a motion compensator which interpolates between the first image and the second image by using at least one of the candidate motion vector and the pseudo motion vector.

7. The image processing apparatus according to claim 6, wherein the pseudo motion vector calculator classifies the candidate motion vector corresponding to peripheral blocks of the candidate motion vector, as predetermined groups, and selects one of center vectors from the predetermined groups as the pseudo motion vector.

8. The image processing apparatus according to claim 7, wherein the pseudo motion vector calculator selects a vector whose value V in a following formula is a largest among the center vectors, as the pseudo motion vector, in which
Vj=(Pj)wp*(Dj)wd
1≦j≦k, k is a number of the predetermined groups;
Dj is a distance between the candidate motion vector and the center vector;
Pj is a number of the candidate motion vectors included in the predetermined groups with respect to the number of candidate motion vectors corresponding to the peripheral blocks; and
wp and wd are a weight value and a constant, respectively.

9. The image processing apparatus according to claim 6, wherein the motion compensator sets a vector having a smaller sum of absolute difference (SAD) between a SAD corresponding to the candidate motion vector and a SAD corresponding to the pseudo motion vector, as a final motion vector, and generates an interpolated image between the first image and the second image by using the final motion vector.

10. The image processing apparatus according to claim 6, wherein the motion compensator determines a covering area or an uncovering area if a difference between the SAD corresponding to the candidate motion vector and the SAD corresponding to the pseudo motion vector exceeds a predetermined value.

11. A motion estimating method comprising:
calculating a first motion vector based on a forward motion estimation or a backward motion estimation from a reference block of a corresponding one of a first image and a second image, and a search area extracted from another of the first and the second images, the first and the second images being consecutive and the second image following the first image;
calculating a second motion vector corresponding to the other of the forward motion estimation and the backward motion estimation by using the first motion vector; and
generating an image between the first and the second images by using at least one of the first motion vector and the second motion vector.

12. The motion estimating method of claim 11, wherein the calculating the first motion vector comprises calculating first motion vectors including the first motion vector,
wherein the calculating the second motion vector comprises:
classifying the first motion vectors into predetermined groups corresponding to peripheral blocks of the first motion vector; and
selecting one of the predetermined groups, as the second motion vector.

13. The motion estimating method of claim 11, wherein the generating the image between the first image and the second image comprises setting a vector having a smaller sum of absolute difference (SAD) between a SAD corresponding to the first motion vector and a SAD corresponding to the second motion vector, as a final motion vector; and
generating an interpolated image between the first image and the second image by using the final motion vector.
